(19) United States
(12) Patent Application Publication
(10) Pub. No.: US 2006/0103530 A1
(43) Pub. Date: May 18, 2006

(54) Shopping cart management system

(76) Inventors: James G. Prather, Yorba Linda, CA (US); Patrick A. Maandag, Corona, CA (US)

Correspondence Address: TERRELL P. LEWIS, UNIT #8, 343 PALOS VERDES BOULEVARD, REDONDO BEACH, CA, 90277, US

(21) Appl. No.: 10/988,277

(22) Filed: Nov. 13, 2004

(51) Int. Cl. G08B 13/14

(52) U.S. Cl. 340/568.5

(57) ABSTRACT

The shopping cart management system includes a consulting module that gathers a customer's present situational awareness and develops a customer specific plan to manage the customer's fleet of shopping carts. An anti-theft shopping cart system includes anti-theft shopping carts having associated anti-theft devices which are constructed and arranged to prevent the shopping carts from being pushed beyond a pre-determined area of the customer's store. A training module trains the customer's employees on proper techniques and procedures regarding cart retention. A cleaning, repair and maintenance module provides cleaning, repair and maintenance of the shopping carts. A cart retrieval module is utilized for retrieving the shopping carts if the carts leave the customer's parking lot. The use of the anti-theft shopping carts optimizes the available useful floor space by reducing the required cart inventory.

### BACKGROUND OF THE INVENTION

1. Field of the Invention

The present invention relates to shopping cart management systems and more particularly to an overall system for servicing, retaining and managing shopping carts utilizing anti-theft devices.

2. Description of the Related Art

The conventional shopping cart was introduced to the public in the 1940s as a convenience to customers while shopping at grocery stores. The advent of the shopping cart permitted customers to collect and purchase more items during a single shopping trip.

Over the last 60 years the shopping cart has been adopted by most of the retail sector as the principal method for collection of items to be purchased during a shopping trip. At first, the cart took the form of a basket carried by the shopper. Then, baskets were mounted on wheeled platforms, such as wagons. Ultimately, baskets mounted on wheeled bases evolved into the conventional shopping carts of today.

As with any piece of equipment, shopping carts require regular service including repairs, maintenance and cleaning. In addition, over the years, theft or temporary loss (through removal from retailer premises by shoppers) of shopping carts has become a major problem for retailers and the community. The theft problem, alone, has added substantial cost to retailers in maintaining fleets of carts because there is a need to increase the size of the cart fleets to take into consideration the loss of carts and the purchase of new carts to replace those carts that cannot be retrieved. Today, municipalities are enacting penalties and fines for carts that are removed from, and left outside of, a store's premises.

Historically, shopping carts have been purchased by end users, such as retailers and markets, and the end users have been responsible for safeguarding, maintaining, cleaning, retrieving and disposing of the shopping carts. Typically, the retailer has contracted out each of these responsibilities to third parties.

In recent years, anti-theft devices have been incorporated into shopping cart systems to minimize the thefts of the shopping carts. For example, U.S. Pat. No. 6,271,755, entitled “Shopping Cart With Improved Theft Disabling Device”, discloses and claims an anti-theft system for a shopping cart that includes a collapsible front suspension mounted between the front side members of a base frame of the shopping car. The front suspension includes a support, a first set of casters mounted to the support, retractable pin means carried by the support and engagable with the side members of the base frame for maintaining the front suspension in an operative mode in which the first set of casters engage a supporting surface, a sensor for detecting a first external signal, apparatus functionally coupled to the sensor for transmitting an activation signal to the retractable pin means to cause retraction of the pin means and render the front suspension inoperative, and a second set of casters fixed to the base frame for preventing the cart from moving in a linear direction, when the front suspension is rendered inoperative.

The '755 patent is a continuation-in-part of U.S. Pat. No. 6,054,923, entitled “Shopping Cart With Theft Disabling Device”. The '923 patent addressed the problem of improper removal of shopping carts from the store's premises, and proposed as a solution a disabling apparatus comprising a combination of structural features borne by the basket supporting frame of the cart to render the cart's wheels inoperative upon actuation of the disabling apparatus. The object of the invention was to make it extremely difficult for a person having the intent to remove the cart from the store's premises by rolling it away.

One major objective of the '755 was to defeat shopping cart theft attempts in situations where the wheels of the shopping cart are disabled but the thief still tries to remove the cart from the premises by tipping the cart so that the disabled wheels are removed from contact with the ground. In this way, the thief can then wheel the cart away on two wheels.

There are also a number of other patents that disclose shopping cart anti-theft devices, including, for example, the following U.S. Pat. No. 4,2422,668 to Herzog (1980); U.S. Pat. No. 5,357,182 to Wolfe et al. (1994); U.S. Pat. No. 4,524,985 to Drake (1985); U.S. Pat. No. 5,576,691 to Coaklet et al. (1996); U.S. Pat. No. 4,577,880 to Bianco (1986); U.S. Pat. No. 4,772,880 to Goldstein (1988); U.S. Pat. No. 5,194,844 to Zelda (1993); and U.S. Pat. No. 4,591,175 to Upton (1986).

The inclusion of anti-theft devices into shopping carts has resulted fewer shopping carts being removed from the market premises by users, with one significant benefit being that the markets themselves need to stock and provide fewer and fewer carts to service the needs of their shoppers. Further, with fewer carts being taken home by shoppers or left in the streets or on sidewalks, the markets have experienced a significant drop in costs associated with servicing, repairing and cleaning the carts.

There thus has become apparent a need for a methodology for efficiently managing an inventory of shopping carts throughout all aspects of the life cycle of a shopping cart.

### SUMMARY OF THE INVENTION

In a broad aspect, the present invention is a method and system for efficiently and cost-effectively managing an inventory of shopping carts in which the inventory includes shopping carts having anti-theft devices.

More specifically, the present invention entails a method and system for managing an inventory of shopping carts which includes consulting with a market to determine its needs, training market employees in the use of an anti-theft shopping cart system, cleaning the carts, repairing and maintaining the carts, and retrieving carts when necessary.

In another aspect of the invention, the step of consulting includes the gathering of a customer's present situational awareness and the development of a customer-specific plan to manage the customer's fleet of shopping carts, the plan being at least a function of the layout of the market and its surroundings and the number of customers that visit the market on a daily basis.

In yet another aspect of the invention, the anti-theft shopping cart system comprises a plurality of shopping carts outfitted with anti-theft devices for disabling the carts when theft of the carts is attempted, thereby preventing the carts from being pushed beyond a predetermined, electronically defined, perimeter about the customer's store.

In still another aspect of the invention, the market's employees are trained in proper techniques and procedures regarding cart retention, and resetting of the anti-theft devices.

Another aspect of the invention entails proper procedures for cleaning, repairing and maintaining the shopping carts outfitted with the anti-theft devices.

In yet another aspect of the invention, the customer is taught the proper procedures for retrieving the shopping carts if the carts leave the customer's parking lot.

Use of the present invention has several advantages over most of the prior art devices/systems. These advantages include the following: (a) it substantially reduces the permanent or temporary loss of shopping carts from the retailers' place of business by preventing carts from being pushed off the retailers' premises; (b) it reduces the costs associated with retrieving shopping carts in the community which is normally done by a cart retrieval company; (c) it reduces the costs associated with cleaning, repairing and maintaining carts because the majority of these expenses occur as a result of shopping carts leaving the retailers' premises where they are subject to misuse and abuse; (d) it substantially reduces the cost of purchasing replacement carts for carts that have been stolen or temporarily lost; and, (e) it provides a single source for providing all of these services to the retailer thereby reducing the administrative and operating expenses, and (f) it optimizes the available useful floor space by reducing the required cart inventory.

### BRIEF DESCRIPTION OF THE DRAWINGS

The sole FIGURE is a schematic diagram illustrating the shopping cart management system of the present invention.

### DETAILED DESCRIPTION OF THE INVENTION

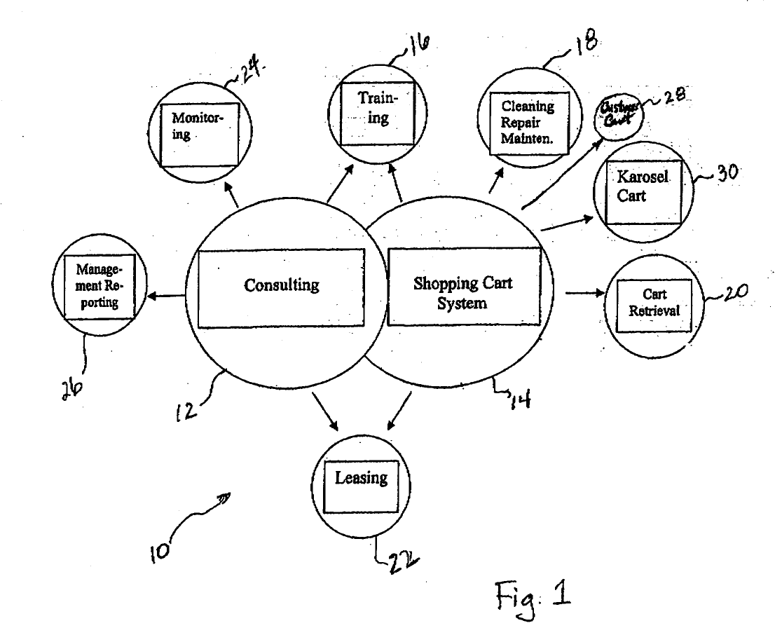

Referring now to the drawings and the characters of reference marked thereon, FIG. 1 illustrates a preferred embodiment of the shopping cart management system of the present invention, designated generally as 10. The shopping cart management system 10 includes a consulting module 12 and an anti-theft shopping cart system 14. The consulting module 12 entails the steps for gathering information relating to the size and limitations of the store of the customer or retailer and for developing a plan to manage the retailer's inventory of shopping carts. The consulting module 12 is the initial step of the system 10. It preferably involves gathering information on the retailer's current processes, procedures, methods and costs and leads to the development of a retailer-specific plan and budget to manage all components of the retailer's inventory of carts. It includes evaluation of each site that is to be covered by the system 10 along with recommendations for specific actions to be taken by the retailer to ensure the safeguarding of the carts at the respective retailer's locations(s). For example, after a retailer's site has been surveyed, a complete list of specific actions will be formalized and presented to the retailer for implementation to assist in the reduction of cart loss and theft. These may include the following:
1) Enhancements to the retailer's property to ensure it is configured to promote the security of shopping carts. This may include the installation of fences and or concrete posts to prevent shopping carts from being removed from areas other than specifically designated exit areas.
2) Procedures for locking up carts during non-business hours outside of the store structure and/or securing them inside the store.
3) Restricting specific areas so that shopping carts cannot enter these areas and be more prone to theft or removal.

The anti-theft shopping cart system 14 includes a plurality of anti-theft shopping carts. Such a shopping cart system is preferably of the type manufactured and distributed under the trademarks UNCART® and “UnCart® System”™, both trademarks owned by Mind Wurx™, L.L.C., Yorba Linda, Calif. This anti-theft shopping cart system is described and/or claimed in U.S. Pat. No's U.S. Pat. No. 6,271,755, entitled “Shopping Cart With Improved Theft Disabling Device” and U.S. Pat. No. 6,054,923, entitled “Shopping Cart With Theft Disabling Device”, both of which are hereby incorporated by reference, in their entireties. The UnCart® cart system includes an UnCart® shopping cart, which is a shopping cart equipped with an UnCart® cart anti-theft device, and an electrical infrastructure (i.e. cabling, controller and signal generator. This system prevents the UnCart® shopping cart from being pushed beyond a pre-determined area, which is normally the parking lot that is used by the retailer.

When the UnCart® shopping cart is pushed to the outer perimeter of the retailer's parking lot, the UnCart® cart anti-theft device is activated by an electrical signal, which is produced by the electrical cable buried under the ground. Upon activation of the UnCart® anti-theft device, the front of the shopping cart drops onto fixed directional casters causing the cart to go in a circle. Thus, the person attempting to take the cart can no longer use it for its intended purpose. This system has dramatically reduced the loss of carts.

The UnCart® shopping carts preferably include advertisements or public service announcements that promote either a product or a public service. The ads are preferably put in a holder in the cart and can be changed at regular intervals.

Although the UnCart® cart system is the preferred system, there are alternate anti-theft shopping cart systems that may be utilized. Some of the other anti-theft device systems include those of the following:
Cartronics®—Manufacturer of an anti-theft device, which utilizes a locking wheel concept. The locking wheel device is activated when the shopping cart is pushed up to or over an electric cable, which is buried in the perimeter of a parking lot. The signal activates a mechanical device, which in essence locks one of the front wheels from turning. (The device creates a potentially unstable condition for the cart as the center of gravity of the cart is elevated and any pressure exerted on either side of the cart can potentially turn the cart over.)
Gatekeeper®—Manufacturer of an anti-theft device, which utilizes a locking wheel concept similar to the Cartronics device above. (This anti-theft device also creates a potentially unstable condition which will result in the cart turning over in the same manner as the Cartronics® device.)
Kart Saver®—Manufacturer of an anti-theft device, which utilizes a locking caster concept. The device is activated similarly to the devices of Cartronics® and Gatekeeper® mentioned above. However, in the anti-theft devices of these manufacturers, it is not the wheel that is locked into place but the caster supporting the wheel. When this device is activated the caster is locked into a position, which causes the shopping cart to go in a circle. This device is more stable than the locking wheel device but still presents a potential risk for the cart to turn over when the shopping cart is pushed at a higher speed.
   Typically, the anti-theft systems of Cartronics®, Gatekeeper®, and Kart Saver® are deficient in that, once the wheel or caster has been locked, under the weight of the purchased goods, the cart can nevertheless continue to be pushed because the locked wheel wears down to a flat surface and acts as a skid thereby permitting continued forward motion of the cart. Further, the anti-theft systems of Cartronics®, Gatekeeper®, and Kart Saver® exhibit another major drawback—whenever the cart wheel has been locked, a shove, push or other force imparted to the side of the cart opposite the locked wheel or locked caster causes the cart itself to roll over. Thus, if a child is seated in the baby seat of the cart when this happens, he/she likely will be thrown out of the cart and sustain great injury.

The foregoing described progression in the technology of anti-theft shopping cart systems has enabled the formulation of an overall shopping cart management system that incorporates all the components required to manage a system of carts throughout their entire life cycle.

The present invention encompasses a “full service” cart management program that allows a store or market to control the acquisition, maintenance, servicing, retrieval (if necessary), and disposal of shopping carts. A key aspect of this program is the use of anti-theft devices, which reduces the loss or theft of carts. The use of anti-theft devices of the type described herein will provide a certain degree of assurance that carts with the anti-theft devices that are provided to a store or market (whether under a sale or a lease) will, for the most part, remain on the premises of the store or market.

Referring again to FIG. 1, there is shown a training module 16, which is associated with the consulting module 12 and the anti-theft shopping cart system 14, for training the retailer's employees on proper techniques and procedures regarding cart retention. The training module 16 encompasses the providing of initial and on-going training to employees on the use of the anti-theft system to ensure safekeeping and maintaining the condition of the shopping carts.

Preferably, the management and employees of the retailer are trained on a number of procedures for eliminating the loss of carts. These procedures may entail, for example, the following:
1) Proper use of the shopping cart system technology including its components—the reset wands, the anti-theft device and the infrastructure (signal generator and cable).
2) How to reset the anti-theft device after it has been activated.
3) Maintaining the proper inventory levels to make sure sufficient shopping carts are available to the customers during business hours.
4) Securing the shopping cart inventory during slow and non-business hours.
5) Recovering unused shopping carts in the parking lot during business hours.

A cleaning, repair and maintenance module 18 is associated with the anti-theft shopping cart system for providing cleaning, repair and maintenance of the shopping carts. Regular cleaning, repair and maintenance preferably involves going to each store periodically and picking up the carts and bringing them back to a warehouse where the carts are cleaned, repaired and maintained. When the carts are picked up replacement carts are dropped off at the store. In essence this is done on a rotating basis, preferably on the order of once every three or four months.

A cart retrieval module 20 is associated with the anti-theft shopping cart system for retrieving the shopping carts if the carts leave the retailer's premises. Cart retrieval is typically necessary where carts outfitted with anti-theft systems other than the UnCart® system is being used. Cart retrieval is effected by driving through the local community to find the retailer's shopping carts that have been removed from the retailer's premises, picking them up and returning them to the retailer.

The shopping cart management system 10 can be implemented under an leasing program 22. The leasing program 22 preferably will cover at least an anti-theft shopping cart system 14 and the consulting module 12 for leasing the anti-theft shopping carts for a desired period of time. The system 10 can be packaged into a full service operating lease. Under the terms of the operating lease the retailer can lease the carts for a specific period of time and at the end of the lease the carts will be returned to the leasing company. The carts can then be reacquired from the leasing company by the service provider and reconditioned and sold or used in other leasing programs. The operating lease preferably covers all costs associated with costs of the management system 10. The retailer makes one monthly lease payment to the leasing company to cover all costs.

A process of cart monitoring is indicated by the module labeled “24” and is associated with the consulting module 12. The purpose of cart monitoring is to determine if the number of carts that are supposed to be at the retailer's store are in fact at the retailers store, and further that procedures specified during the consulting step are being adhered to, and that the condition of the carts is being tracked. Preferably, each month a site visit is made to each store to determine if the number of carts that are supposed to be at the store are there and that the condition of the carts is acceptable. In addition, the site visit will entail observing the store personnel to determine if they are following all procedures to ensure the safeguarding of the carts. The monthly monitoring also initiates the cleaning and repair service if warranted and the cart retrieval service if needed.

Module 26 represents a process of management reporting, which is preferably carried out with the process encompassed by the consulting module 12 for reporting the number of carts at each retailer's store, the condition of the shopping carts and the performance of the retailer's personnel. Each month the retailer gets a report which shows the number of carts at each store, the condition of the carts, and a performance evaluation of the respective store to let them know if the employees are following procedures. This step, as with other steps of the invention described herein, may be effected by way of the internet through a website.

In addition to using carts incorporating anti-theft devices, as discussed above, the system 10 of the present invention may also include a system 28 of customer-owned, light-weight, personal shopping carts. One example of a personal shopping cart that could be used in such a customer owned system is a folding shopping cart manufactured by Mind Wurx™, LLC and sold under the trademark MiCart®. The MiCart® shopping cart is a relatively small, inexpensive, double-decker, folding, personal hand cart which is used to transport groceries and/or other items from a retailer's store to the shopper's home. This type of cart eliminates the need for the shopper to take a conventional shopping cart from the retailer's premises to transport their groceries home.

The shopping cart management system 10 also preferably uses a modified conventional shopping cart, known as the Karosel™ cart system 30. The Karosel™ cart, a form of “go-back” cart, comprises a conventional shopping cart that has been structurally modified, as for example by securing the rear gate against pivoting and/or providing reinforcement for the cantilevered basket. Carts so modified can be used by the retailer for internal purposes only, including transporting trash to a dumpster or trash compactor, transporting merchandise throughout the store for the purposes of stocking, or restocking, of the shelves and other general purposes uses. The Karosel™ cart eliminates the need for the employees of the retailer to use UnCart® shopping carts for the very same purposes.

Complete management of all the above aspects of the present invention is preferably provided by a dedicated Program Manager (not shown) who is assigned the respective retailer's account. The Program manager ensures that all operational and administrative responsibilities have been completed.

One significant advantage of the present invention is that the shopping cart management system and process optimizes the useful floor space, that is the floor space that can be available to the retailer to conduct his business, by reducing the required cart inventory. For example, a typical retail grocery store of average size will require 250-300 carts in a situation where theft deterrent devices are not used in conjunction with the carts, or where theft of carts is still an issue for the grocery store. On the other hand, in the same typical retail grocery store, the use of the present invention enables reduction of the shopping cart inventory, sometimes by a factor of at least 2, and therefore the floor space of the store that can be used by the retailer to conduct his business is substantially increased.

The leasing aspect of the present invention also provides the following additional advantages:

The retailer has to deal with only one vendor instead of many vendors, and as a result, the store's administrative expenses are reduced.

The retailer does not have to expend resources to dispose of carts at the end of the lease as the leasing company can buy back the carts at the end of the lease.

The retailer incurs substantially lower costs to maintain a fleet of carts because far less carts are lost.

Other embodiments and configurations may be devised without departing from the spirit of the invention and the scope of the appended claims.

1. A shopping cart management system, comprising:
a) a consulting module for gathering a customer's present site requirements and to develop a customer-specific procedure to manage the customer's fleet of shopping carts;
b) an anti-theft shopping cart system comprising a plurality of anti-theft shopping carts having associated anti-theft devices, said anti-theft shopping cart system being constructed and arranged to prevent said shopping carts from being removed from a predetermined area including the customer's premises, said anti-theft shopping cart system being based on said customer specific plan;
c) a training module associated with said consulting module and said anti-theft shopping cart system for training the customers employees on proper techniques and procedures regarding cart retention;
d) a cleaning, repair and maintenance module associated with said anti-theft shopping cart system for providing cleaning, repair and maintenance of said plurality of shopping carts; and,
e) a cart retrieval module associated with said anti-theft shopping cart system for retrieving said shopping carts if the carts leave the predetermined area associated with the customer's premises,
wherein, the use of said anti-theft shopping carts optimizes the available useful floor space within the customer's premises by reducing the required cart inventory.

2. The shopping cart management system of claim 1 further comprising a leasing program covering at least said anti-theft shopping cart system and said consulting module for leasing said anti-theft shopping carts for a desired period of time.

3. The shopping cart management system of claim 1 further comprising a cart monitoring module associated with said consulting module for determining if the number of carts that are supposed to be at the customer's premises are in fact at the customer's premises and procedures associated with cart monitoring and retention are being adhered to.

4. The shopping cart management system of claim 1, wherein monitoring the customer's shopping carts includes reporting the number of carts at each customer's store, the condition of said shopping carts and the performance of the customer's personnel.

5. The shopping cart management system of claim 1, wherein at least one shopping cart includes advertisements located thereon.

6. The shopping cart management system of claim 1, further comprising a plurality of relatively lightweight, consumer owned shopping carts.

7. The shopping cart management system of claim 1, further comprising an internal purpose cart system for use by the store employees.

8. The shopping cart management system of claim 1, wherein said anti-theft shopping carts comprise carts claimed in U.S. Pat. No. 6,271,755.

9. The shopping cart management system of claim 1, wherein said anti-theft shopping carts comprise carts claimed in U.S. Pat. No. 6,054,923.

10. A method for managing a shopping cart inventory, comprising:
determining a customer's shopping cart inventory needs,
providing the customer with a shopping cart system including an inventory of shopping carts, wherein at least the majority of said shopping carts have actuatable anti-theft devices, and
tracking the use and condition of said shopping carts on a periodic basis to maintain control over the inventory and to determine that the inventory is intact.

11. The method of claim 10, wherein said step of determining a customer's shopping cart inventory needs comprises determining how many anti-theft shopping carts are needed at the customer's premises, determining a perimeter about the customer's premises, and installing an electronic system for actuating the anti-theft devices when any of said carts bearing the anti-theft devices crosses over the perimeter.

12. The method of claim 10, wherein said step of providing the customer with a shopping cart system includes the step of training the customer's employees on the proper techniques and procedures for cart retention, including the manner in which the actuated anti-theft devices are to be reset.

13. The method of claim 10, further including the steps of cleaning and repairing said carts.

14. The method of claim 10, wherein said step of providing an inventory of shopping carts further includes providing a set of collapsible personal hand carts to the customer so that shoppers at the customer's store can transport their purchased goods from the customer's premises to their home or other similar destination.

15. The shopping cart management system of claim 10, wherein said anti-theft shopping carts comprise carts claimed in U.S. Pat. No. 6,271,755.

16. The shopping cart management system of claim 10, wherein said anti-theft shopping carts comprise carts claimed in U.S. Pat. No. 6,054,923.

17. A method for optimizing useful floor space in a store that utilizes shopping carts, comprising the steps of:
a) gathering information pertaining to a customer's present site requirements and developing a customer-specific plan to manage the customer's fleet of shopping carts;
b) deploying an anti-theft shopping cart system, said anti-theft shopping cart system comprising a plurality of anti-theft shopping carts having associated anti-theft devices, said anti-theft shopping cart system being constructed and arranged to prevent said shopping carts from being pushed beyond a predetermined area about the customer's premises, said anti-theft shopping cart system being based on said customer specific plan;
c) training the customer's employees on proper techniques and procedures regarding cart retention;
d) providing cleaning, repair and maintenance of said plurality of shopping carts; and,
e) retrieving said shopping carts if the carts leave the customer's parking lot,
wherein the use of said anti-theft shopping carts optimizes the available useful floor space by reducing the required cart inventory.

18. The method of claim 17, further comprising the step of monitoring said carts for determining if the number of carts that are supposed to be at the customer's store are in fact at the customer's store and said procedures are being adhered to.

19. The method of claim 17, further comprising the step of reporting the number of carts at each customer's store, the condition of said shopping carts and the performance of the customer's personnel.

20. The method of claim 17, and further comprising the step of monitoring said carts for determining if the number of carts that are supposed to be at the customer's store are in fact at the customer's store and said procedures are being adhered to.

21. The method of claim 17, and further comprising the step of reporting the number of carts at each customer's store, the condition of said carts, and the performance of the customer's personnel.

22. The method of claim 17, wherein all said steps are performed as part of a leasing program.

23. The shopping cart management system of claim 17, wherein said anti-theft shopping carts comprise carts claimed in U.S. Pat. No. 6,271,755.

24. The shopping cart management system of claim 17, wherein said anti-theft shopping carts comprise carts claimed in U.S. Pat. No. 6,054,923.
